(19) United States
(12) Patent Application Publication
(10) Pub. No.: US 2009/0007469 A1
(43) Pub. Date: Jan. 8, 2009

(54) Changeable-image display card

(75) Inventor: Yoshimasa Kamimoto, Tokyo-To (JP)

Correspondence Address: LADAS & PARRY LLP, 26 WEST 61ST STREET, NEW YORK, NY, 10023, US

(73) Assignee: KAMIMOTO & COMPANY, LTD.

(21) Appl. No.: 11/999,469

(22) Filed: Dec. 5, 2007

(30) Foreign Application Priority Data
Jul. 5, 2007 (JP) 2007- 5152

(51) Int. Cl. G09F 1/00

(52) U.S. Cl. 40/124.191

(57) ABSTRACT

A changeable-image display card is built by combining a pouch 2 and two inner cards 12₁, and 12₂. Outer cards 1₁ and 1₂ forming one wall of the pouch 2, and the two inner cards are provided with predetermined numbers of flaps 7, 8, 13 and 14 extending along the width of the outer and the inner cards, respectively. The flaps 7, 8, 13 and 14 are inserted in opening formed when the flaps 7, 8, 13 and 14 are formed such that the adjacent flaps 7, 8, 13 and 14 partly overlap each other, and the inner cards can be pulled relative to the outer cards by a distance equal to the width of the openings. Different images including pictures and characters are formed on the flaps of the inner and the outer cards, respectively. The image formed on the inner card and the image formed on the outer card are displayed alternately by pulling and pushing the inner cards relative to the outer cards by the distance S equal to the width of the flaps.

### BACKGROUND OF THE INVENTION

1. Field of the Invention

The present invention relates to a changeable-image display card and, more particularly, to a changeable-image display card applicable to a variety of cards including message cards, post cards and emas, namely, votive tablets.

2. Description of the Related Art

Changeable-image display cards intended mostly for toys for children and playthings like tricky pictures are disclosed in JP-B S51-40488, JP-U S51-17995 and JP-B S55-6638. Such a changeable-image display card is made by cutting each of a plurality of sheets like cardboards to form sheets provided with a plurality of rectangular flaps and a plurality of openings corresponding to the rectangular flaps, inserting the flaps of the sheets in the openings of the adjacent sheets, superposing the sheets, and connecting an end of the movable one of the sheets to an end part of a cover covering the surface of the stationary one of the sheets by connecting members. When the cover is opened, the connecting member pulls out the movable sheet to change pictures and characters marked on the flaps.

In each of the changeable-image display cards disclosed in the foregoing cited references, the pictures are changed when the movable sheet is moved by opening the cover. This changeable-image display card is used for enjoying the moving-picture effect of changes of pictures by opening the cover. Therefore, any picture cannot be seen while the cover is closed, it is difficult to see the entire process of changes while the cover is being opened, and hence the use of this changeable-image display card is limited.

### SUMMARY OF THE INVENTION

It is an object of the present invention to provide a flat changeable-image display card capable of alternately displaying two kinds of images including pictures and characters, of omitting operations for opening and closing a cover, of thoroughly showing the process of change of the images caused by linearly pulling a movable card, and of being widely applied to Christmas cards, congratulatory message cards, post cards, votive tablets and such.

The present invention provides a changeable-image display card including: a pouch having an outer card provided with a predetermined number of rectangular flaps formed by cutting the outer card so as to extend along the width of the outer card; and two inner cards each provided with a predetermined number of substantially rectangular flaps extending along the width of the inner card, and combined with the pouch by inserting the substantially rectangular flaps thereof in openings corresponding to the rectangular flaps of the outer card such that the substantially rectangular flaps of the inner cards partly overlap those of the outer card, and the inner cards can be pulled relative to the outer card by a distance corresponding to the width of the openings; wherein different images including pictures and characters are marked on the rectangular flaps of the outer card and the inner cards, respectively, and the image including pictures and characters and marked on the substantially rectangular flaps of the outer card is changed for the image including pictures and characters and marked on the substantially rectangular flaps of the inner card by pulling out the inner card by a distance corresponding to the width of the substantially rectangular flaps.

In the changeable-image display card according to the present invention, one side of the substantially quadrilateral pouch may be protruded in a V-shape to form a V-shaped protrusion, an eyelet may be formed in the V-shaped protrusion near the top of the V-shaped protrusion to form the changeable-image display card in the shape of a votive tablet, and at least one raised part to be used as a guide for guiding one side of the inner cards when the inner cards are pulled may be formed near the bottom side of the V-shaped protrusion.

The changeable-image display card can be used as a mail card, a greeting card to be attached to a gift or the like by forming the quadrilateral pouch in the shape of an envelope, providing each of the inner cards with a closing flap, inserting the inner cards each provided with the closing flap into the pouch such that the respective flaps of the inner cards are inserted into the openings of the pouch, respectively, marking messages, pictures or such associated with the messages on each card, and displaying a concealed image by pulling the inner card relative to the pouch after opening the pouch.

Preferably, the opposite corners of each rectangular flap are beveled to shape the rectangular flap in a trapezoid to ensure that the inner card can be smoothly pulled and to facilitate assembling.

The inner card of the changeable-image display card of the present invention can be pulled out linearly by pinching an end part of the inner card between fingers and pulling the inner card. Therefore, the continuous process of change of the images marked on the pouch for that marked on the inner card can be demonstrated to attract the user's interest.

The inner card of the changeable-image display card of the present invention can be pulled out linearly by pinching an end part of the inner card between fingers and pulling the inner card. Therefore, the changeable-image display card is flat and thin. Thus the changeable-image display card can be applied to uses in a wide range including postcards, picture postcards of tourist resorts, message cards, instruction cards for goods, free gifts and such.

Images may be those of things which change with time, such as buds of flowers and blooming flowers and those of things which move, such as racehorses. Racehorses look like running when the inner card is quickly reciprocated. The changeable-image display card can be applied to New Year's gifts and games.

### BRIEF DESCRIPTION OF THE DRAWINGS

The above and other objects, features and advantages of the present invention will become more apparent from the following description taken in connection with the accompanying drawings, in which:

FIG. 1A is a development of a first outer card included in a pouch;

FIG. 1B is a plan view of a second outer card included in the pouch;

FIG. 2A is a plan view of a combination of the first and the second outer card;

FIG. 2B is a sectional view taken on the line A-A in FIG. 2A;

FIG. 2C is a rear view of the combination of the first and the second outer card, respectively;

FIG. 3A is a plan view of a first inner card;

FIG. 3B is a plan view of a second inner card;

FIG. 4A is a plan view of a combination of the first and the second inner card shown in FIG. 3;

FIG. 4B is a sectional view taken on the line B-B in FIG. 4A;

FIG. 4C is a rear view of the combination of the first and the second inner card;

FIG. 5A is a plan view of a combination of the outer cards included in the pouch and the second inner card;

FIG. 5B is a sectional view taken on the line C-C in FIG. 5A;

FIG. 5C is a plan view of the combination of the outer card and the inner card, in which the inner card is pulled;

FIG. 5D is a sectional view taken on the line D-D in FIG. 5C;

FIG. 6A is a plan view of a changeable-image display card, in which the inner card is inserted in the pouch;

FIG. 6B is a plan view of the changeable-image display card, in which the inner card has been pulled by a distance S;

FIG. 7 is a development of a pouch of a changeable-image display card in the form of a votive tablet;

FIG. 8A is a front elevation of the changeable-image display card shown in FIG. 7;

FIG. 8B is a rear view of the changeable-image display card shown in FIG. 7;

FIG. 8C is a sectional view taken on the line E-E in FIG. 8B;

FIG. 9A is a front elevation of the changeable-image display card displaying an image when the inner cad is inserted in the pouch;

FIG. 9B is a front elevation of the changeable-image display card displaying another image when the inner card is pulled;

FIG. 10 is a development of a pouch of a changeable-image display card in the form of an envelope;

FIG. 11 is a development of the changeable-image display card shown in FIG. 10;

FIG. 12 is a development of a combination of a pouch and an inner card;

FIG. 13A is a plan view of a changeable-image display card in a state where an inner card is inserted in a pouch; and

FIG. 13B is a plan view of the changeable-image display card shown in FIG. 13A in a state where the changeable-image display card has been opened and a message card has been pulled.

### DESCRIPTION OF THE PREFERRED EMBODIMENTS

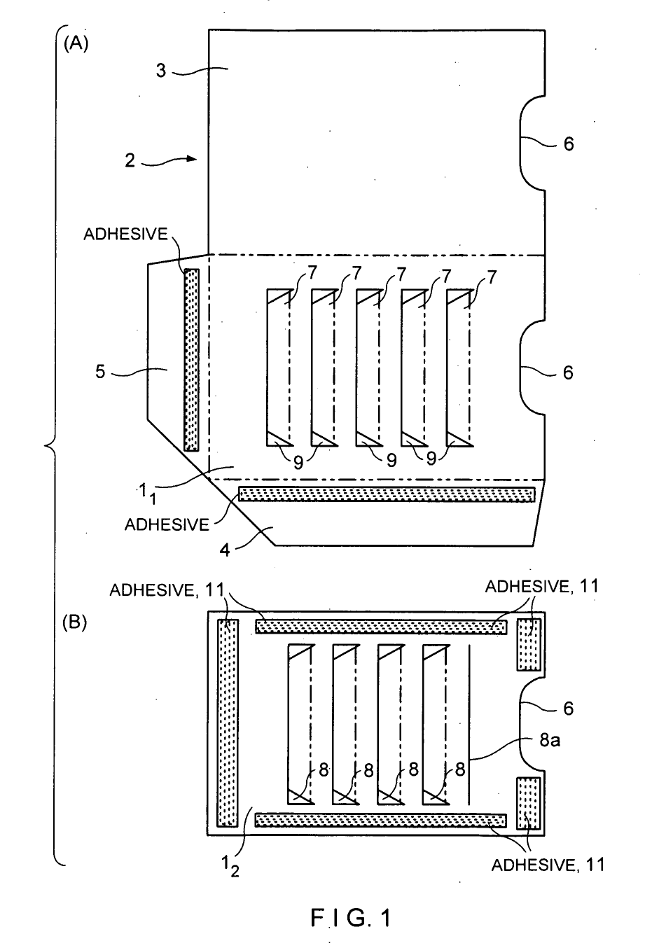

A changeable-image display card in a first embodiment according to the present invention will be described with ref to FIGS. 1 to 6. FIG. 1A is a development of a pouch 2 combined with a first outer card 1₁, and FIG. 1B is a plan view of a second outer card 1₂. The pouch 2 has the first outer card 1₁, a back cover 3 continuously extending from a first side of the first outer card 1₁, a sticking tab 4 continuously extending from a second side of the first outer card 1₁ and a sticking tab 5 continuously extending from a third side of the outer card 1₁ and forming the bottom of the pouch 2. A fourth side of the first outer card 1₁, a side of the back cover 3 corresponding to the fourth side of the first outer card 1₁, and a side of the second outer card 1₂ corresponding to the fourth side of the first outer card 1₁ are provided with recesses 6, respectively.

The first outer card 1₁ of the pouch 2 has five flaps 7 formed by slitting the first outer card 1₁. The long sides of the flaps 7 extend along the width of the first outer card 1₁. The second outer card 1₂ has four flaps 8 similar to the flaps 7, and a slit 8a.

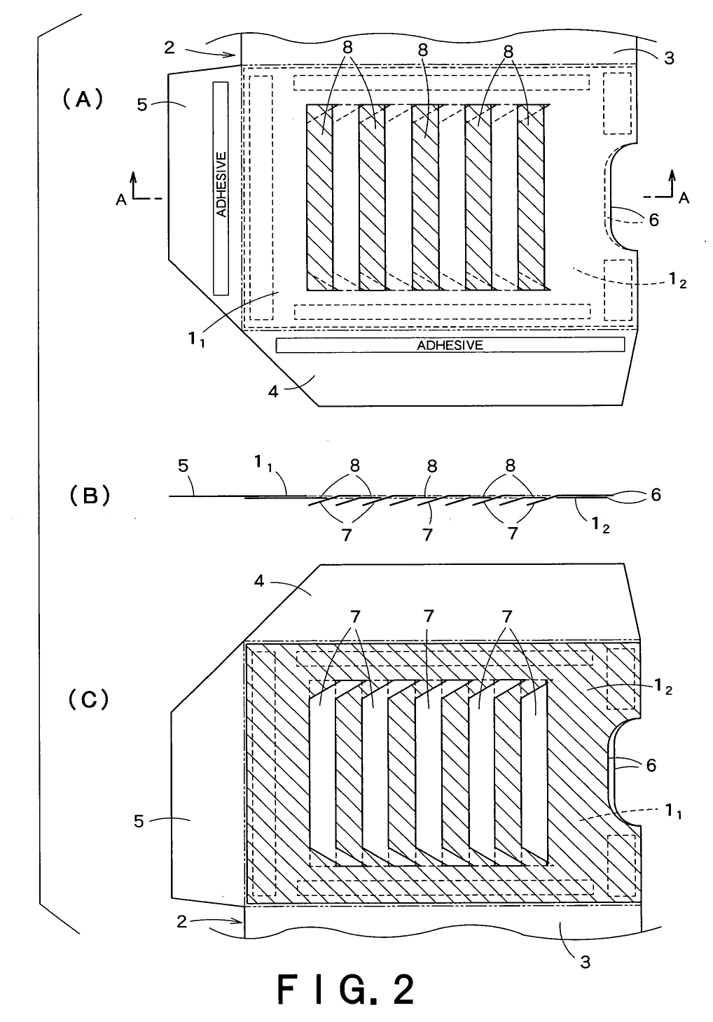

As shown in FIG. 2B, the flaps 8 of the second outer card 1₂ are passed through openings 9 formed in the first outer card 1₁ so as to correspond to the flaps 7, and an adhesive part 11 of the second outer card 1₂ is attached to the first outer card 1₁ to combine the first outer card 1₁ and the second outer card 1₂. A double coated adhesive tape may be used instead of the adhesive part 11.

Corners of the flaps 7 and 8 are cut to form the flaps 7 and 8 in a trapezoidal shape.

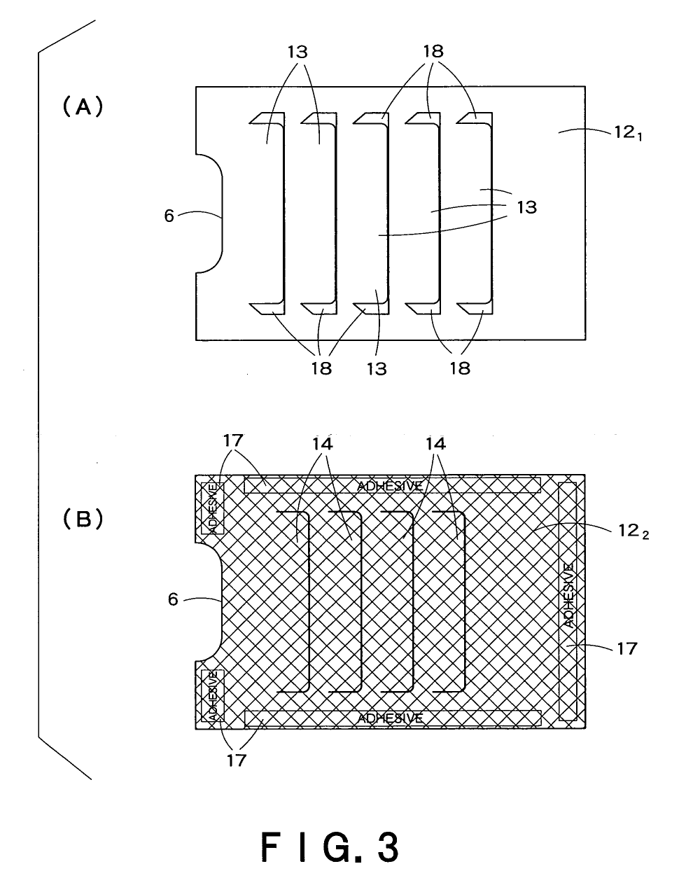

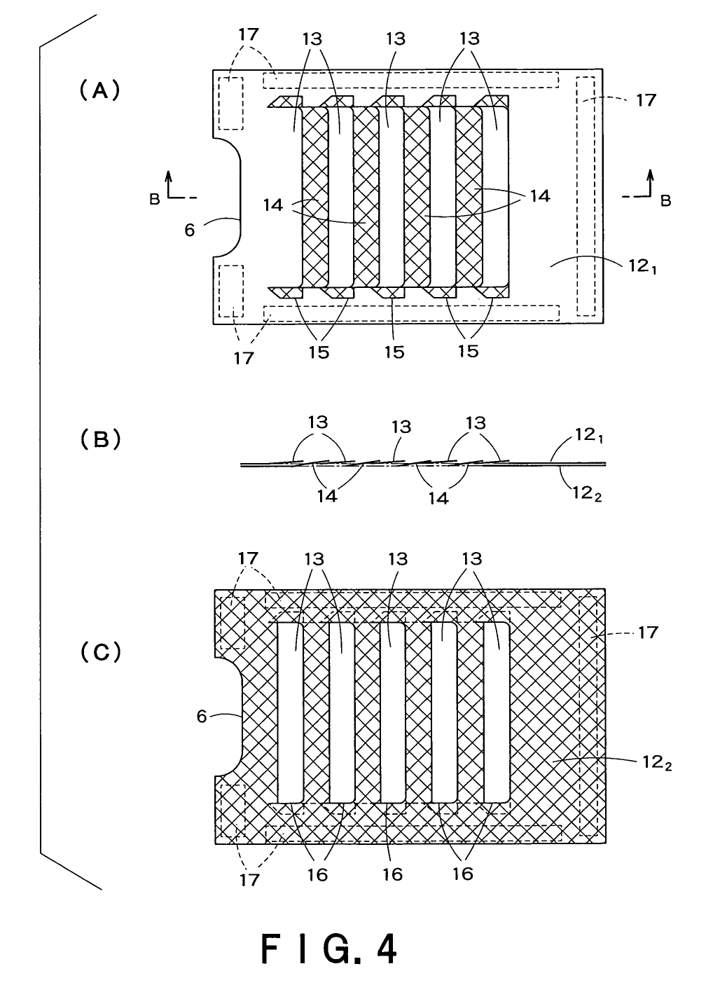

FIGS. 3A and 3B show a first inner card 12₁ and a second inner card 12₂. The first inner card 12₁ has five flaps 13 formed by slitting the first inner card 12₁ and protruding in a direction opposite a direction in which the respective flaps 7 and 8 of the outer cards 1₁ and 1₂ protrude. The second inner card 12₂ has four flaps 14 formed by slitting the second inner card 12₂. The first inner card 12₁ and the second inner card 12₂ are combined as shown in FIGS. 4A and 4C by passing the flaps 13 of the first inner card 12₁ and the flaps 14 of the second inner card 12₂ through openings 16 of the second inner card 12₂ and openings 15 formed in the first inner card 12₁, respectively, such that the flaps 13 of the first inner card 12₁ and the flaps 14 of the second inner card 12₂ overlap each other as shown in FIG. 4B. The first inner card 12₁ and the second inner card 12₂ are bonded together by adhesive parts 17.

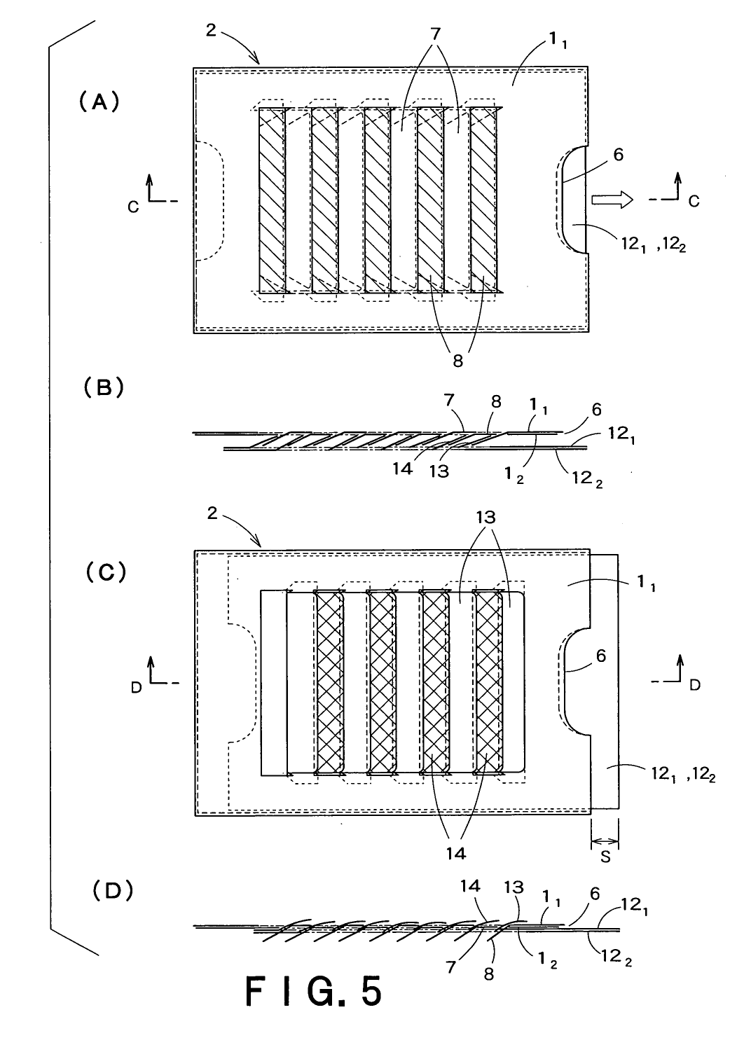

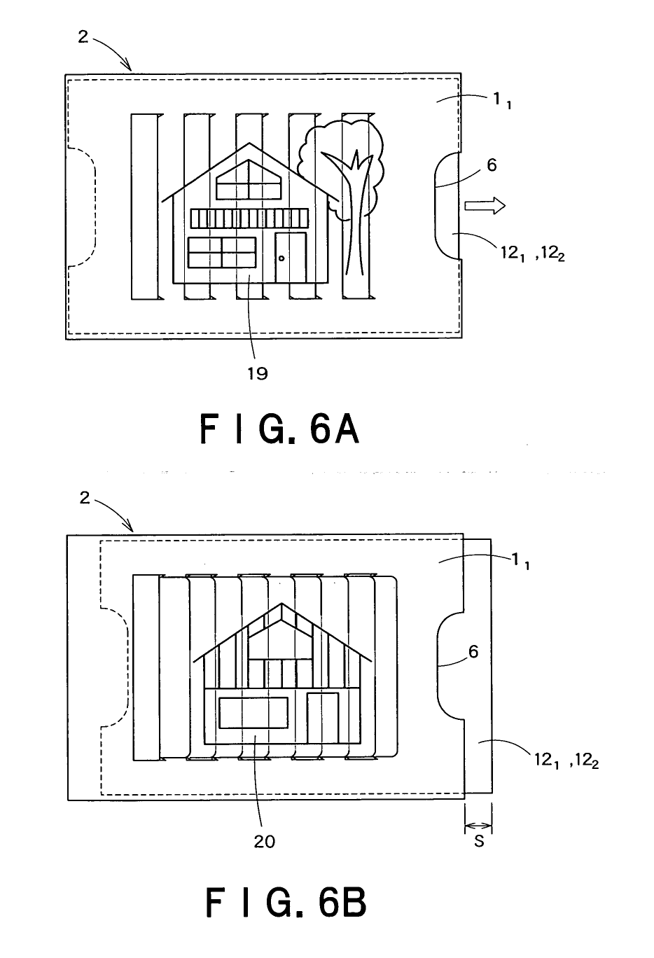

FIGS. 5A, 5B and 5C show the changeable-image display card completed by inserting the combination of the inner cards 12₁ and 12₂ in the pouch 2. As shown in FIG. 5B, the flaps 7 of the first outer card 1₁, the flaps 8 of the second outer card 1₂, the flaps 13 of the first inner card 13 and the flaps 14 of the second inner card 12₂ are passed through the openings 9, 10, 15 and 16 to combine the outer cards 1₁ and 1₂ and the inner cards 12₁ and 12₂. As shown in FIG. 5D, the inner cares 12₁ and 12₂ can be pulled relative to the outer cards 1₁ and 1₂ by a distance S equal to the width of the flaps 7 and 13. Suppose that a picture 19 of a house before reforming as shown in FIG. 6A is printed on the surfaces of the flaps 7 of the first outer card 1₁ and the flaps of the second outer card 1₂ and a picture 20 of the house after reforming as shown in FIG. 6B are printed on parts of the surfaces of the flaps 13 and 14 of the inner cards 12₁ and 12₂ which are visible when the inner cards 12₁ and 12₂ are pulled. When the inner cards 12₁ and 12₂ inserted in the pouch 2 are pulled by a distance S in a state shown in FIG. 6A, in which the inner cards 12₁ and 12₂ are inserted in the pouch 2, the picture 19 is changed for the picture 20.

The picture 19 is changed for the picture 20 simply by linearly pulling the inner cards 12₁ and 12₂ by the distance S. Therefore, the process of changing the picture 19 for the picture 20 can be observed, which increases interest.

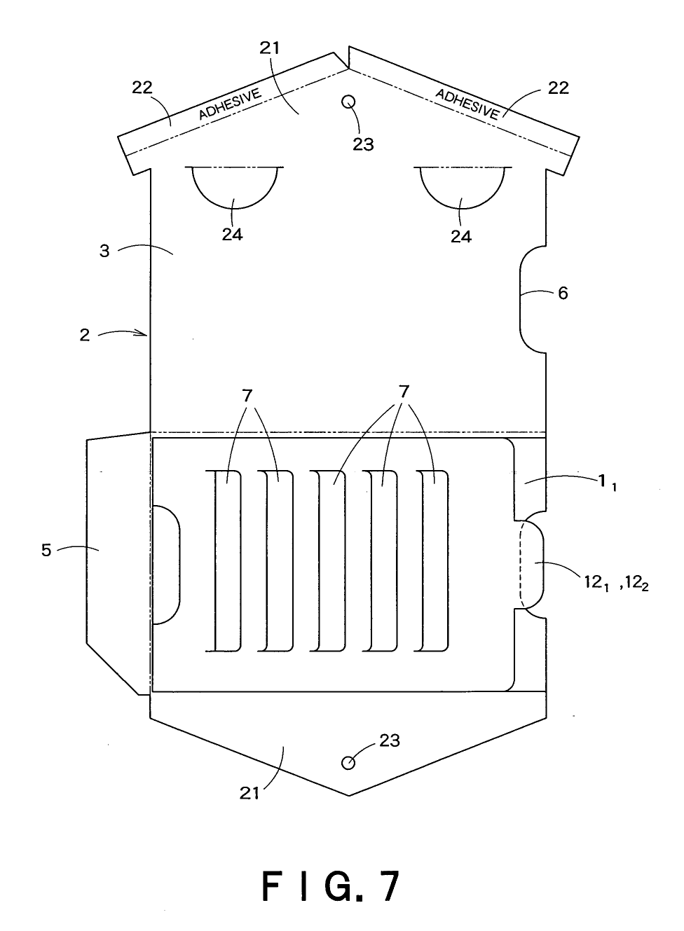

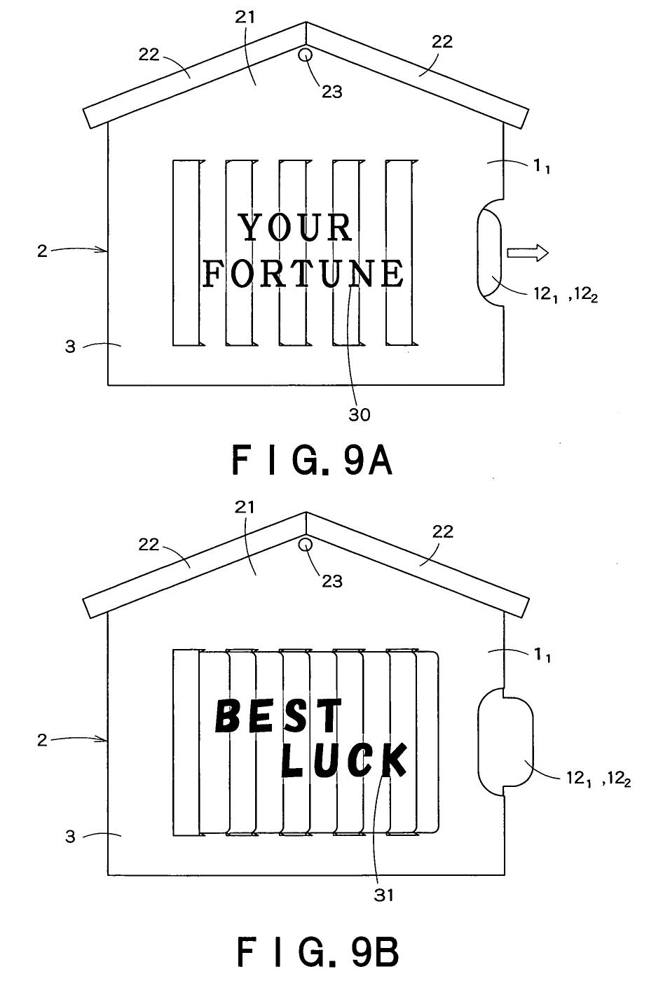

FIGS. 7 to 9 show a changeable-image display card in a second embodiment according to the present invention formed in the shape of a votive tablet. The first outer card 1₁ and the back cover 3 of the pouch are provided with V-shaped flaps 21 continuously extending from the corresponding sides of the first outer card 1₁ and the back cover 3, respectively. The V-shaped extension 21 of the back cover 3 is provided with sticking tabs 22 continuously extending from the inclined outer edges of the V-shaped extension 21. The V-shaped extensions 21 are put together and the sticking tabs 22 of the back cover 3 are bonded to the V-shaped extension 21 of the first outer card 1₁ to form the pouch 2 in the shape of a votive tablet as shown in FIG. 9. The V-shaped extensions 21 are provided with eyelets 23. A hanging string is passed through the eyelets 23.

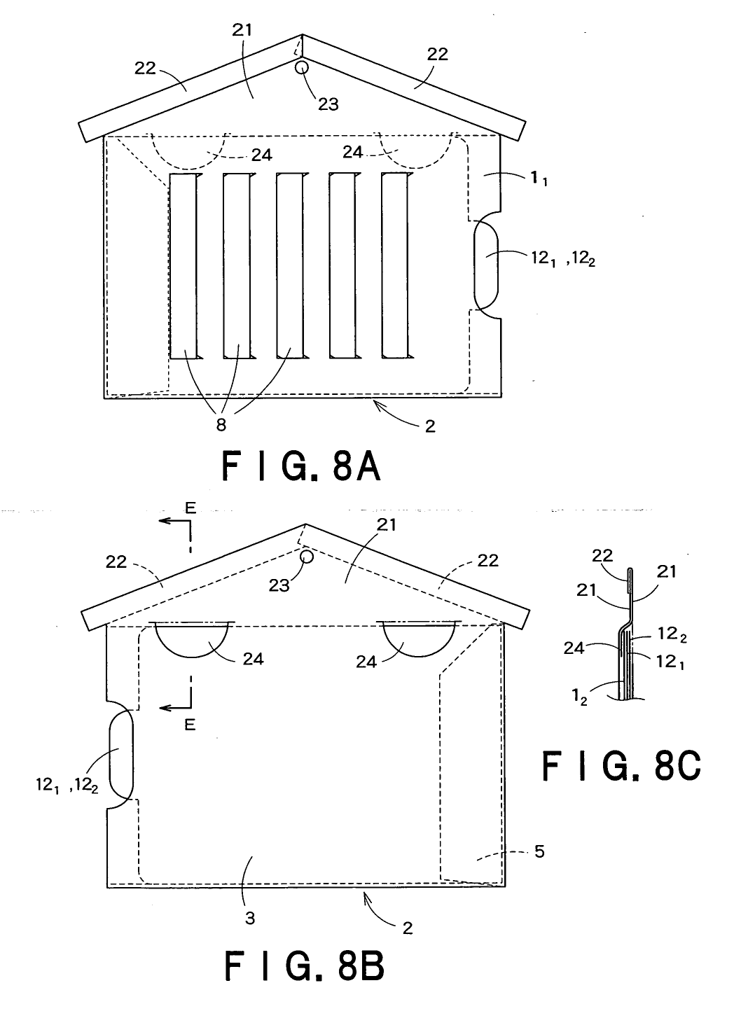

Parts of the back cover 3 extending from the bottom side of the V-shaped extension 21 of the back cover 3 are cut to form raised parts 24. As shown in FIG. 8C, the raised parts 24 guide sides of the inner cards 12₁ and 12₂ inserted in the pouch 2 to ensure the smooth sliding motion of the inner cards 12₁ and 12₂ in the pouch 2.

Outer cards 1₁ and 1₂ of the pouch 2 and the inner cards 12₁ and 12₂ of the changeable-image display card in the second embodiment are the same in configuration as those of the changeable-image display card in the first embodiment and hence the description thereof will be omitted.

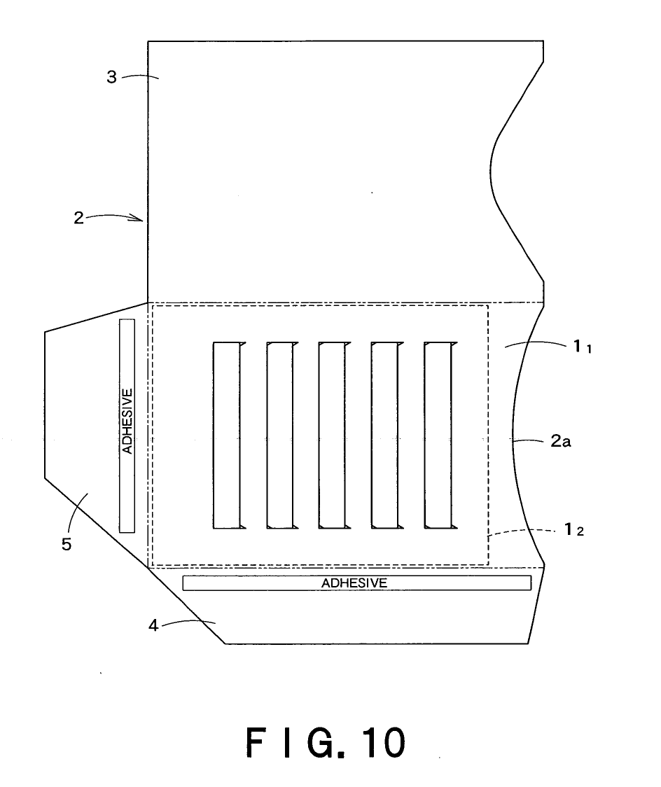

FIGS. 10 to 13 shown a changeable-image display card in a third embodiment according to the present invention intended for use as an envelope in which a congratulatory message card 25 or a letter is given as a gift or sent by mail. This changeable-image display card has the shape of a rectangular envelope.

As shown in FIG. 10, a pouch 2 is formed by combining a first outer card 1₁ and a second outer card 1₂. The pouch 2 has an open end 2a defined by concavely curved end edges.

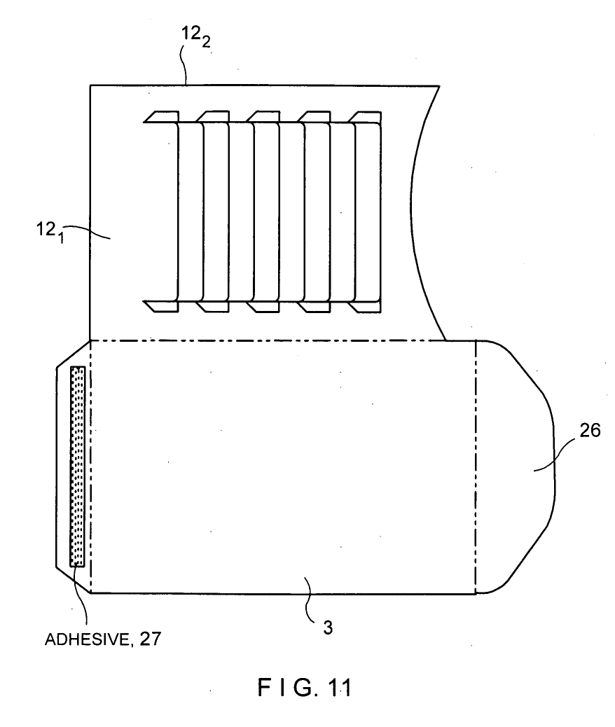

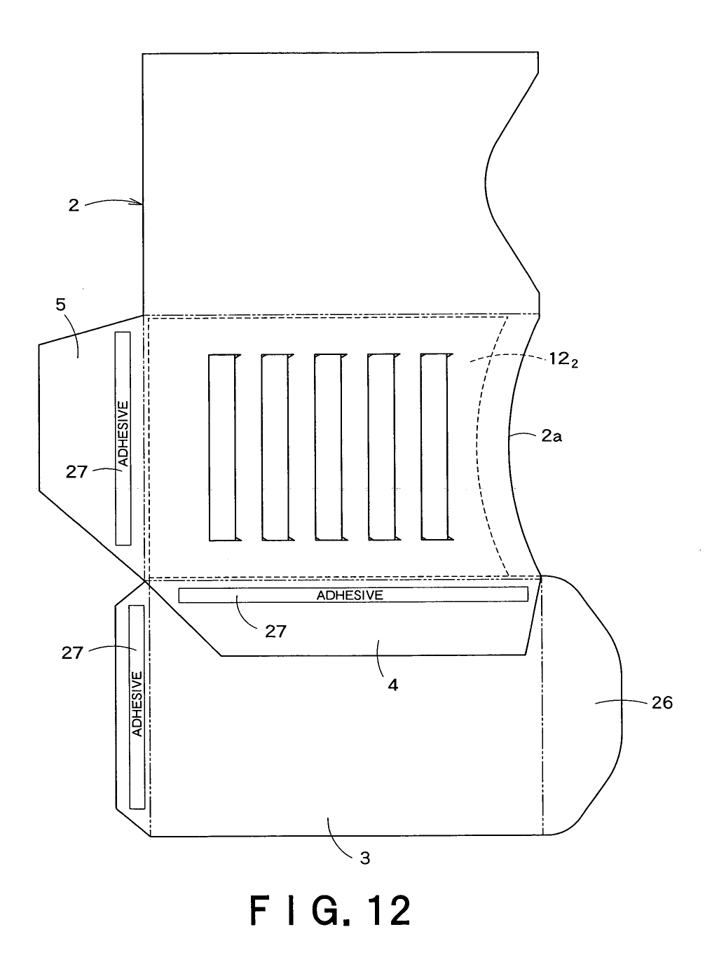

Referring to FIG. 11, the inner cards 12₁ and 12₂ are continuous with one side of a back cover 3 formed in a width such that the back cover 3 can be inserted into the pouch 2 and provided with a closing flap 26 having a part that projects slightly from the open end 2a of the pouch 2. As shown in FIG. 12, the inner cards 12₁ and 12₂ and the outer cards 1₁ and 1₂ of the pouch 2 are the same in shape as those of the foregoing embodiments and are combined in the same manner as those of the foregoing embodiments.

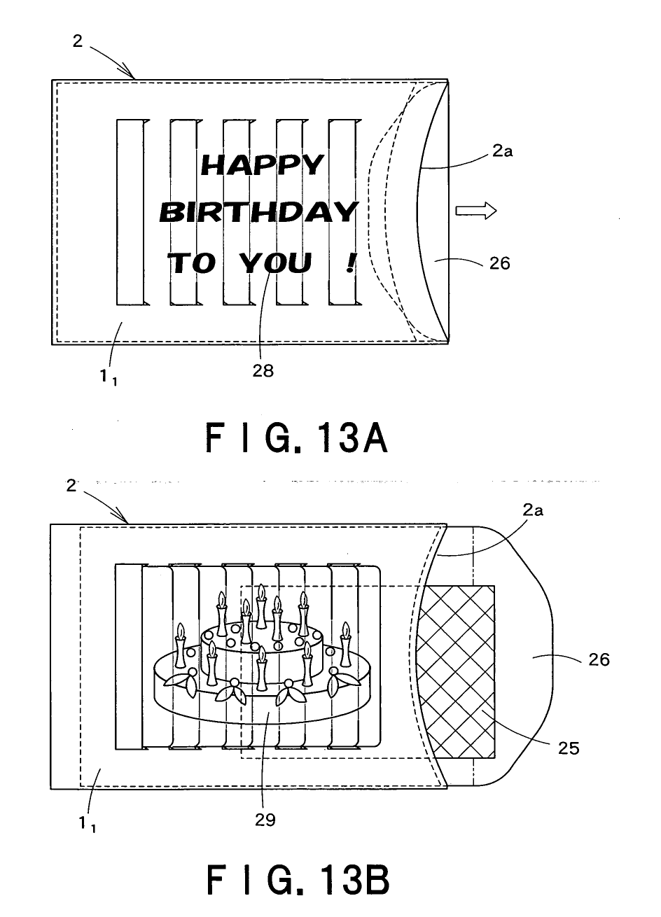

Parts of the pouch 2 are folded in the shape of an envelope as shown in FIG. 13 and are pasted together by adhesive parts 27. The message card 25 or the like is inserted into the pouch 2 and the closing flap 26 closed to complete the changeable-image display card. The changeable-image display card can be sent by mail as a gift. When the changeable-image display card is designed to display auspicious pictures, the changeable-image display card can be used as a pouch for containing money as a gift at the New Year or a congratulatory gift.

A person received the changeable-image display card opens the changeable-image display card and can pull the back cover 3 of the inner card 12₁ by a distance S. Consequently, an image 28 of a picture and/or characters marked on the outer card is changed for an image 29 marked on the inner card and, at the same time, the message card 25 can be taken out from the changeable-image display card.

The respective numbers of the flaps 7, 8, 13 and 14 of the outer and the inner cards may be optionally determined according to the size and type of the changeable-image display card. The pictures 19 and 20 and characters 27 may be printed by a proper printing method, such as an offset printing method, a silk-screen printing method, a hot stamping method or an ink-jet printing method.

When a picture of a house before reforming is printed on either of the pouch including the outer cards 1₁ and 1₂ and the inner cards 12₁ and 12₂, and a picture of a house after reforming is printed on the other, the pictures can be used for demonstrating changes that can be made by reforming. One of the pictures may be a picture of a house under construction and the other may be a picture of a finished house. Sales activities for contracts for reformation can be promoted by alternately showing the pictures of the house before and after reformation. Customer's understanding of a method of constructing a house can be deepened by showing pictures of the house under construction to the customer and attractions of a newly built house can be propagandized by showing a picture of a finished house. Thus sales activities for contracts for newly built houses can be promoted.

The changeable-image display card can demonstrate the effect of animations by using a pouch and inner cards on which pictures of a winged creature, such as a flapping bird, a flying butterfly or a flying insect, and by quickly repeating pulling and pushing the inner cards to make the winged creature look like flapping.

When a picture of a pitcher in a pitching motion is printed on either of the pouch and the inner card, and a picture of a batter in a batting motion is printed on the other of the pouch and the inner card, motions of the pitcher and the batter can be displayed. When pictures of a basketball player in shooting motions or pictures of a football player in shooting motions are printed on the pouch and the inner card, motions of the basketball or the football player can be displayed. Customers can buy changeable-image display cards provided with pictures of their favorite players to enjoy watching motions of their favorite players.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

1. A changeable-image display card comprising:
a pouch having an outer card provided with a predetermined number of substantially rectangular flaps formed by cutting the outer card so as to extend along width of the outer card; and
two inner cards each provided with a predetermined number of substantially rectangular flaps extending along width of the inner card, and combined with the pouch by inserting the substantially rectangular flaps thereof in openings corresponding to the rectangular flaps of the outer card such that the substantially rectangular flaps of the inner cards partly overlap those of the outer card, and the inner cards can be pulled relative to the outer card by a distance corresponding to width of the openings;
wherein different images including pictures and characters are marked on the rectangular flaps of the outer card and the inner cards, respectively, and the image including pictures and characters and marked on the substantially rectangular flaps of the outer card are changed for the image including pictures and characters and marked on the substantially rectangular flaps of the inner cards by pulling out the inner card relative to the outer card by a distance corresponding to width of the substantially rectangular flaps.

2. A changeable-image display card comprising:
a quadrilateral pouch having a part forming a first outer card provided with a predetermined number of flaps;
a second outer card provided with a number of flaps smaller by one than the number of the flaps of the first outer card, inserted in openings corresponding to the flaps of the first outer card such that the flaps partly overlap those of the first outer card;
a first inner card provided with a predetermined number of flaps equal to the number of the flaps of the first outer card, protruding in a direction opposite a direction in which the flaps of the first outer card protrude; and
a second inner card provided with a number of flaps smaller by one than the number of the flaps of the first inner card, inserted in openings corresponding to the flaps of the first inner card such that the flaps partly overlap those of the first inner card;
wherein the first and the second inner card are inserted into the pouch such that the flaps thereof are inserted in the openings corresponding to the flaps of the first outer card such that the flaps of the first and the second inner card partly overlap the flaps of the first outer card, and the first and the second inner card can be moved relative to the pouch by pulling by a distance equal to width of the flaps of the first and the second inner card, and a first and a second image are formed on the flaps that appears in the openings of the first outer card, and on the flaps of the inner cards that appear on an outer surface of the first outer card when the inner cards are pulled, respectively.

3. The changeable-image display card according to claim 1, wherein one side of the substantially quadrilateral pouch is protruded in a V-shape to form a V-shaped protrusion, an eyelet for a hanging string is formed in the V-shaped protrusion near the top of the V-shaped protrusion to shape the pouch in the shape of a votive tablet, and at least one raised part to be used as a guide for guiding sides of the inner cards when the inner cards are pulled is formed near the bottom side of the V-shaped protrusion.

4. The changeable-image display card according to claim 1, wherein the pouch is formed in a shape of a rectangular envelope, the inner cards are provided at an end thereof with a closing flap, the inner cards are inserted into the pouch, the flaps and the openings of the two cards are combined, a desired image of a picture and such is formed on each of the cards, and a message card or the like can be sealed in the pouch.

5. The changeable-image display card according to claim 1, wherein opposite ends of each of the flaps are beveled.

6. The changeable-image display card according to claim 1, wherein a picture of a house under construction or before reformation is formed on either of the outer card and each of the inner cards, and a picture of a finished house or a house after reformation is formed on the other of the outer card and each of the inner cards.

7. The changeable-image display card according to claim 1, wherein images formed on the outer card and each of the inner cards are two pictures of a flapping winged creature, such as a flapping bird or a flying butterfly, and the inner cards are repeatedly pulled and pushed quickly to make the winged creature looks like flapping.

8. The changeable-image display card according to claim 1, wherein the images are pictures of an athlete in motion.

9. The changeable-image display card according to claim 8, wherein the images formed on the pouch and each of the inner cards are a picture of a pitcher in a pitching motion and a picture of a batter in a batting motion.
